(19) United States
(12) Patent Application Publication
(10) Pub. No.: US 2013/0008015 A1
(43) Pub. Date: Jan. 10, 2013

(54) APPARATUS AND METHODS FOR TIGHTENING THREADED FASTENERS

(76) Inventor: John K. Junkers, Saddle River, NJ (US)

(21) Appl. No.: 13/577,889

(22) PCT Filed: Feb. 8, 2011
(86) PCT No.: PCT/US2011/024114

§ 371 Date: Aug. 8, 2012

Related U.S. Application Data
(60) Provisional application No. 61/302,481, filed on Feb. 8, 2010.

(51) Int. Cl. B23P 19/06; F16B 31/04; B25B 29/02

(52) U.S. Cl. 29/525.02; 81/54

(57) ABSTRACT

According to a first aspect of the invention we provide an apparatus for tightening a threaded fastener including:—a pulling device, threadedly engageable with an extruding part of a shank of a fastener, which pulls the shank, the pulling device having:—a first pull setting which achieves closure of a joint; a second pull setting which substantially frees a nut from a surface of the closed joint; a turning device, engageable with the nut, which turns the nut on the shank, the turning device having:—a torque setting which turns the nut with a predetermined torque to maintain joint closure; a turn setting which turns the nut by a predetermined degree of rotation; and at least one controlling device which controls the pulling and turning devices. According to a second aspect of the invention we provide a method for tightening a threaded fastener including:—pulling an extruding part of a shank of the fastener to achieve closure of a joint; torquing a nut to maintain joint closure; pulling the shank to free the nut from a surface of the closed joint; and turning the nut substantially by a predetermined degree of rotation.

### CROSS REFERENCE TO RELATED APPLICATION

This Application is a continuation application of co-pending U.S. Application Ser. No. 61/302,481, having Filing Date of Feb. 8, 2010, entitled “Hydraulic Tensioner” an entire copy of which is incorporated herein by reference.

### DESCRIPTION OF INVENTION

This invention relates to an apparatus for tightening a threaded fastener. More particularly, this invention relates to apparatus for tightening threaded fasteners such as for example hydraulic tensioners.

Fluid-operated tools of the above general type are known in the art. In particular, tools are known in which one element pulls the stud by a given force so as to elongate it. Another element of the tool turns a nut on the stud until it cannot be turned further so as to retain the achieved elongation. The one element thereafter relaxes the stud which tightens the nut on a joint. While known, mechanisms for coordination of the application of pulling forces on studs and turning forces on nuts are quite complicated.

Clamping force accuracy between all fasteners is necessary to achieve adequate joint closure. Independent tests indicate stud load variations of up to ±51% for known hydraulic tensioners which are inherently imprecise due to variations in operator methods and bolting application characteristics. Some operators for example tighten threaded fasteners snugly by hand. Some operators tighten threaded fasteners with the assistance of a hammer. And still others use bar extensions to increase applied torque. These variations in operator methods alter stud elongation, yield imprecise and varied stud loads and are unrepeatable. Stud elongation in many cases is less than 1/40^{th} of an inch and in short studs virtually not perceivable by the human eye. A quarter nut turn in either direction means the difference between over- and under-stretched studs leading to loosened or failed joint connections.

Bolting application characteristics increase inaccuracies inherent in joint closure. These characteristics include: varied friction from unclean, kinked or debris-laden stud, nut and flange threads and surfaces; galled stud, nut and flange surfaces; disoriented and misaligned studs, nuts and flanges; and unevenly lubricated stud, nut and flange threads and surfaces.

The present invention has therefore been devised to address these issues.

The technology disclosed in the present application advances technology disclosed in the following commonly owned patents, entire copies of which are incorporated herein by reference: U.S. Pat. No. 5,318,397, having Issue Date of Jun. 7, 1994, entitled “Mechanical Tensioner for and Method of Elongating and Relaxing a Stud and the like”; U.S. Pat. No. 5,398,574, having Issue Date of Mar. 21, 1995, entitled “Fluid Operated Tool”; U.S. Pat. No. 5,341,560, having Issue Date of Aug. 30, 1994, entitled “Method of Elongating and Relaxing a Stud”; U.S. Pat. No. 5,460,867, having Issue Date of Apr. 18, 1995, entitled “Mechanical Tensioner”; U.S. Pat. No. 5,538,379, having Issue Date of Jul. 23, 1996, entitled “Mechanical Tensioner for and Method of Elongating and Relaxing a Stud and the like”; and U.S. Pat. No. 5,713,558, having Issue Date of Feb. 3, 1998, entitled “Hydraulic Tensioner”.

According to a first aspect of the invention we provide an apparatus for tightening a threaded fastener including:—
a pulling device, threadedly engageable with an extruding part of a shank of a fastener, which pulls the shank, the pulling device having:—
   a first pull setting which achieves closure of a joint;
   a second pull setting which substantially frees a nut from a surface of the closed joint;
a turning device, engageable with the nut, which turns the nut on the shank, the turning device having:—
   a torque setting which turns the nut with a predetermined torque to maintain joint closure;
   a turn setting which turns the nut by a predetermined degree of rotation; and
at least one controlling device which controls the pulling and turning devices.

According to a second aspect of the invention we provide a method for tightening a threaded fastener including:—
pulling an extruding part of a shank of the fastener to achieve closure of a joint;

torquing a nut to maintain joint closure;
pulling the shank to free the nut from a surface of the closed joint; and
turning the nut substantially by a predetermined degree of rotation.

Generally the invention solves problems of the prior art by first establishing a joint closure by means for pulling the bolt to seat the two joint faces. The nut is turned down at a pre-torque to keep the established joint closed while the bolt is under a pulling force. Once the nut is seated, the tensioner pulls the bolt further to elongate it. The nut is substantially freed so that it can be turned at a given angle before the pulling force is released and the bolt relaxes to maintain the required bolt load. This has the advantage that each bolt retains the same elongation and thus provides the same joint compression. The pre-torque is relatively low compared to the final torque required to turn the nut further at the predetermined angle. The pre-torque may still vary between several fasteners, however, the small difference between them remains substantially similar rather than increasing with the torque increase required for turning the nut at a predetermined number of degrees.

Further features of the invention are set out in claims 2 to 44 appended hereto.

The invention will now be described by way of example only with reference to the accompanying drawings, of which:—

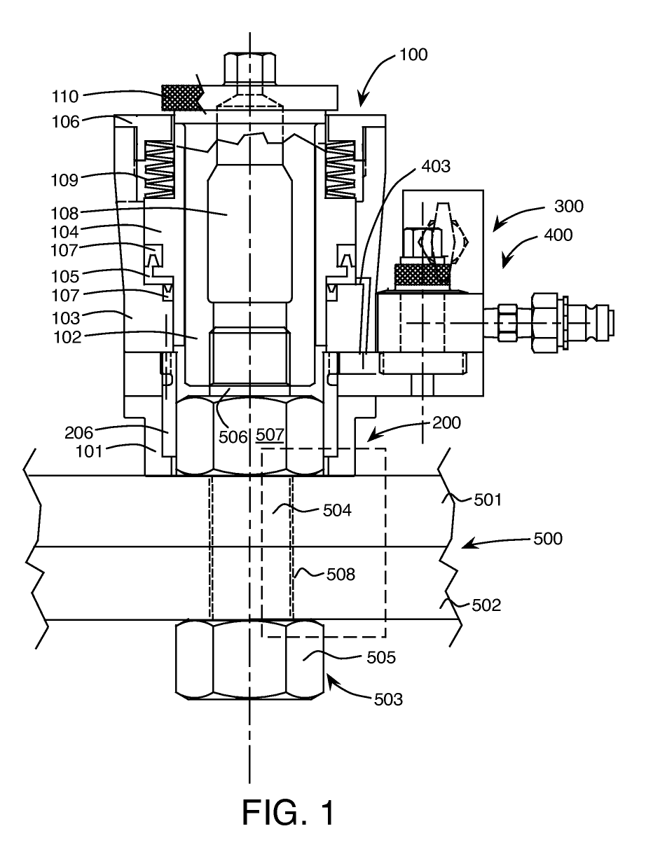

FIG. 1 is a side, cross-sectional view, of a first embodiment of the present invention;

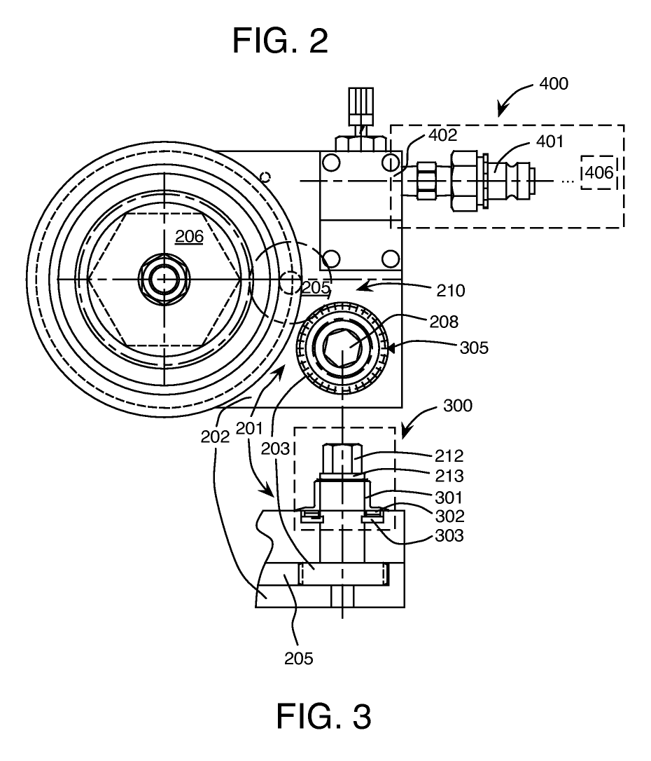

FIG. 2 is a top view of the first embodiment of the present invention; and

FIG. 3 is a side, cross-sectional view, of a portion of the first embodiment of the present invention.

Referring to FIG. 1, this shows a first embodiment of an apparatus 1 for tightening a threaded fastener 503. Apparatus 1 may be used to fasten members together into a joint 500, such as flat members 501 and 502, which are fastened in face-to-face relation by fastener 503, commonly known in the art as a ‘screw’. A head 505 of fastener 503 is adjacent to an exposed face of flat member 502. Head 505 may act on flat member 502 via a washer.

Generally, fastener 503 is of the kind having a shank 504; a nut 507 which is threadedly engageable with shank 504; and a part 506 of shank 504 which extrudes from an end face of nut 507. Shank 504 extends axially through a bore 508 in flat members 501 and 502.

A pulling device 100 includes: a base cylinder 101; a cylinder sleeve 102; a cylinder 103; a piston 104; a lower nut 105; and upper nut 106; fluid seals 107; a puller bar 108; piston springs 109; a piston return adaptor 110; and a load holding valve 111.

Referring to FIG. 2, this shows a top down view of the first embodiment of apparatus 1. A turning device 200 includes: a gear box assembly 201; a base plate 202; a driving gear 203; an intermediate driving gear 205; a gear-driven socket 206; a nut turning hex 208; a gear train 210; a driving hex 212; and a retaining ring 213.

A controlling device 300 includes: a rotation angle indicating dial 301; a wave spring 302; a keyed washer 303; and an indicator output 305.

A power device 400 includes: fluid quick couplers 401; a manifold 402; fluid lines 403; and a fluid source 406.

Apparatus 1 may use pulling device 100, turning device 200, controlling device 300 and power device 400 to close joint 500. In another example, apparatus 1 tightens fastener 503 with use of a variation of turning device 200 engageable with nut 507. The variation of turning device 200 includes: a torque setting which turns nut 507 to a predetermined torque to either achieve, maintain or achieve and maintain closure of joint 500; and a turn setting which turns nut 507 by a predetermined degree of rotation.

In another example, apparatus 1 tightens fastener 503 with use of the variation of turning device 200 engageable with nut 507 and a variation of pulling device 100. The variation of pulling device 100 is threadedly engageable with extruding part 506 of shank 504, and pulls shank 504 with a pull setting which closure of joint 500.

In another example the pull setting of pulling device 100 is a first pull setting and pulling device 100 has a second pull setting which substantially frees nut 507 from a surface of closed joint 500.

As shown in FIGS. 1-3, controlling device 300 includes a rotation angle indicating device which is configured to sense the predetermined degree of rotation of nut 507. A variation of controlling device 300 may control pulling device 100 and turning device 200 and variations thereof and may include a mechanical or electronic angle/rotary encoder to determine the degree of rotation. The encoder may turn off power device 400 once the desired turn of nut 507 is achieved.

During the first pull setting pulling device 100 pulls shank 504 at a force substantially to the point of elongation, which may be within +20% of the point of elongation. The force required to pull the shank to the point of elongation is larger than a force required to achieve joint closure. Additionally the second pull setting pulls shank 507 at a force larger than the first pull setting. Further during the second pull setting the force required to pull the shank to free the nut from the surface of the closed joint is larger than both the forces required to achieve joint closure and to initiate elongation of the shank. The force required to pull the shank to the point of elongation may be calculated, observed and/or estimated with known methods including: torque control tightening; angle control tightening; yield control tightening; bolt stretch method; heat tightening; use of tension indicating methods; and/or from known sources.

The predetermined torque to either achieve, maintain or achieve and maintain joint closure may be calculated, observed and/or estimated with known methods or from known sources. Also the predetermined degree of rotation may be calculated, observed and/or estimated with known methods and/or from known sources.

In one example above the following method is used: after completing the first pull setting the controlling device activates the turning device; the controlling device maintains the force applied to the shank during the first pull setting at least until the start of the second pull setting; after completing the torque setting the controlling device activates the pulling device; after completing the second pull setting the controlling device activates the turning device; the controlling device senses when the nut turns the predetermined degree of rotation; and the controlling device prevents the turning device from exceeding the predetermined degree of rotation.

Advantageously after reaching the predetermined degree of rotation the pulling device relaxes the shank which results in substantially even, predetermined, precise and/or repeatable shank load and substantially even, predetermined, precise and/or repeatable nut tightness.

The turn setting may be set either mechanically, manually, hydraulically, electronically or any combination thereof. The pulling device and the turning device may be driven by either same or different hydraulic power devices. The pulling device and the turning device may be driven by either hydraulic, pneumatic, electric, manual or any combination thereof power devices. In another example, the pulling device may be driven by either hydraulic, pneumatic, electric, manual or any combination thereof power device and the turning device may be driven by an other of hydraulic, pneumatic, electric, manual or any combination thereof power devices.

Controlling device 300 is configured to either turn on or off power device 400 when controlling device 300 senses the predetermined degree of rotation of nut 507. While not shown in FIGS. 1-3, hydraulic means and ratcheting means and other known tensioner and tooling components may be used for the components of apparatus 1. An encoder, as part of controlling device 300, could be used to cease power to apparatus 1 once desired joint characteristics are achieved.

In addition to or in lieu of an encoder the turning device may be supported on an axle and wherein the controlling device senses a predetermined angular twist or torsional load in the axle. Furthermore the controlling device may include a clutch which is configured to slip when the controlling device senses the predetermined degree of rotation.

The invention of the present application may further be described as a hydraulic tensioner having connecting means to connect to a bolt end on one side of a joint. The bolt has an axis and its other end is connected along the axis toward the other side of the joint. At least one nut is between the connecting means and the one side of the joint. A pressure controlled pulling means to pull the bolt and controlled turning means to turn the nut are present. The pressure controlled pulling means has a first pressure setting to pull the bolt to achieve joint closure. The controlled turning means turn the nut at a predetermined torque to assure that the joint remains closed. The hydraulic pressure operated pulling means has at least a second pressure setting to pull and elongate the bolt further and to free the nut off the joint. The controlled turning means has a second setting to turn the nut by a predetermined degree so that when the pressure is relieved from the pressure controlled pulling means, the bolt relaxes and the nut tightens up to keep a predetermined bolt load in the bolt.

It will be understood that each of the elements described above, or two or more together, may also find a useful application in other types of constructions differing from the types described above. The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

While the invention has been illustrated and described as embodied in a fluid operated tool, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

When used in this specification and claims, the terms “comprising”, “including”, “having” and variations thereof mean that the specified features, steps or integers are included. The terms are not to be interpreted to exclude the presence of other features, steps or components.

What is claimed is:

1. An apparatus for tightening a threaded fastener including:—
a turning device, engageable with a nut, which turns the nut on a part of a shank which extrudes from an end face of the nut, the turning device having:—
a torque setting which turns the nut to a predetermined torque to either achieve, maintain or achieve and maintain joint closure;
a turn setting which turns the nut by a predetermined degree of rotation; and
a controlling device which controls the turning device.

2. An apparatus according to claim 1 including:—
a pulling device, threadedly engageable with the extruding part of the shank, which pulls the shank, the pulling device having a pull setting which achieves joint closure; and
wherein the controlling device controls the pulling device.

3. An apparatus according to claim 2 wherein the pull setting is a first pull setting and wherein the pulling device has a second pull setting which substantially frees the nut from a surface of the closed joint.

4. An apparatus according to claim 3 wherein during the first pull setting the pulling device pulls the shank at a force substantially to the point of elongation.

5. An apparatus according to claim 4 wherein during the first pull setting the pulling device pulls the shank at a force within ±20% of the point of elongation.

6. An apparatus according to claim 4 wherein the force required to pull the shank to the point of elongation is larger than a force required to achieve joint closure.

7. An apparatus according to claim 3 wherein during the second pull setting the pulling device pulls the shank at a force larger than the first pull setting.

8. An apparatus according to claim 3 wherein during the second pull setting the force required to pull the shank to free the nut from the surface of the closed joint is larger than both the forces required to achieve joint closure and to initiate elongation of the shank.

9. An apparatus according to claim 1 wherein during the turn setting the nut is rotated further than in the torque setting.

10. An apparatus according to claim 3 wherein the force required to pull the shank to the point of elongation may be calculated, observed and/or estimated with known methods.

11. An apparatus according to claim 10 where in the force required to pull the shank to the point of elongation may be calculated, observed or estimated with known methods including: torque control tightening; angle control tightening; yield control tightening; bolt stretch method; heat tightening; use of tension indicating methods; and/or from known sources.

12. An apparatus according to claim 1 wherein the predetermined torque to either achieve, maintain or achieve and maintain joint closure may be calculated, observed and/or estimated with known methods or from known sources.

13. An apparatus according to claim 1 wherein the predetermined degree of rotation may be calculated, observed and/or estimated with known methods and/or from known sources.

14. An apparatus according to claim 3 wherein after completing the first pull setting the controlling device activates the turning device.

15. An apparatus according to claim 3 wherein the controlling device maintains the force applied to the shank during the first pull setting at least until the start of the second pull setting.

16. An apparatus according to claim 2 wherein after completing the torque setting the controlling device activates the pulling device.

17. An apparatus according to claim 2 wherein after completing the second pull setting the controlling device activates the turning device.

18. An apparatus according to claim 1 wherein the controlling device prevents the turning device from exceeding the predetermined degree of rotation.

19. An apparatus according to claim 1 wherein the controlling device senses when the nut turns the predetermined degree of rotation.

20. An apparatus according to claim 2 wherein after reaching the predetermined degree of rotation the pulling device relaxes the shank which results in substantially even, predetermined, precise and/or repeatable shank load and substantially even, predetermined, precise and/or repeatable nut tightness.

21. An apparatus according to claim 3 including:—
wherein after completing the first pull setting the controlling device activates the turning device;
wherein the controlling device maintains the force applied to the shank during the first pull setting at least until the start of the second pull setting;
wherein after completing the torque setting the controlling device activates the pulling device;
wherein after completing the second pull setting the controlling device activates the turning device;
wherein the controlling device senses when the nut turns the predetermined degree of rotation; and
wherein the controlling device prevents the turning device from exceeding the predetermined degree of rotation.

22. An apparatus according to claim 21 wherein after reaching the predetermined degree of rotation the pulling device relaxes the shank which results in substantially even, predetermined, precise and/or repeatable shank load and substantially even, predetermined, precise and/or repeatable nut tightness.

23. An apparatus according to claim 1 wherein the turn setting is set either mechanically, manually, hydraulically, electronically or any combination thereof.

24. An apparatus according to claim 2 wherein the pulling device and the turning device are driven by either same or different hydraulic power devices.

25. An apparatus according to claim 2 wherein the pulling device and the turning device are driven by either hydraulic, pneumatic, electric, manual or any combination thereof power devices.

26. An apparatus according to claim 2 wherein the pulling device is driven by either hydraulic, pneumatic, electric, manual or any combination thereof power device and wherein the turning device is driven by either hydraulic, pneumatic, electric, manual or any combination thereof power device.

27. An apparatus according to claim 22 wherein the controlling device is configured to either turn on or off the power source(s) when the controlling device senses the predetermined degree of rotation.

28. An apparatus according to claim 2 wherein the turning device is supported on an axle and wherein the controlling device senses a predetermined angular twist in the axle.

29. An apparatus according to claim 2 wherein the turning device is supported on an axle and wherein the controlling device senses a predetermined torsional load in the axle.

30. An apparatus according to claim 2 wherein the controlling device includes a clutch which is configured to slip when the controlling device senses the predetermined degree of rotation.

31. An apparatus according to claim 2 wherein the controlling device includes a rotation angle indicating device and wherein the controlling device is configured to sense the predetermined degree of rotation.

32. An apparatus according to claim 2 wherein the controlling device includes a rotary encoding device and wherein the controlling device is configured to sense the predetermined degree of rotation.

33. An apparatus for tightening a threaded fastener of the kind having:—
a shank; and
a nut which is threadedly engageable with the shank;
wherein a part of the shank extrudes from an end face of the nut;
the apparatus including:—
a pulling device, threadedly engageable with the extruding part of the shank, which pulls the shank, the pulling device having:—
a first pull setting which achieves closure of a joint;
a second pull setting which substantially frees the nut from a surface of the closed joint;
a turning device, engageable with the nut, which turns the nut on the shank, the turning device having:—
a torque setting which turns the nut with a predetermined torque to maintain joint closure;
a turn setting which turns the nut by a predetermined degree of rotation; and
at least one controlling device which controls the pulling and turning devices.

34. A method for tightening a threaded fastener including:—
torquing, with a turning device, a nut on a shank to a predetermined torque to either achieve, maintain or achieve and maintain joint closure; and
turning, with the turning device, the nut by a predetermined degree of rotation.

35. A method according to claim 34 including:—
pulling, with a pulling device, the shank to achieve joint closure; and
wherein the torquing step maintains joint closure.

36. A method according to claim 35 including:—
wherein the pulling step of claim 34 is a first pulling step; and
pulling, with the pulling device in a second pulling step, the shank to substantially free the nut from a surface of the closed joint.

37. A method according to claim 36 including:—
wherein the pulling step of claim 34 is a first pulling step; and
pulling, with the pulling device in a second pulling step, the shank to substantially free the nut from a surface of the closed joint.

38. A method according to claim 37 wherein after the first pulling step a controlling device activates the turning device.

39. A method according to claim 38 wherein a controlling device maintains the force applied to the shank during the first pull setting at least until the start of the second pulling step.

40. A method according to claim 39 wherein after the torquing step the controlling device activates activates the pulling device.

41. A method according to claim 40 wherein after the second pulling step the controlling device activates the turning device.

42. A method according to claim 41 wherein the controlling device prevents the turning device from exceeding the predetermined degree of rotation.

43. A method according to claim 42 wherein the controlling device senses when the nut turns the predetermined degree of rotation.

44. A method according to claim 43 wherein after reaching the predetermined degree of rotation the pulling device relaxes the shank which results in substantially even, predetermined, precise and/or repeatable shank load and substantially even, predetermined, precise and/or repeatable nut tightness.

45. A method for tightening a threaded fastener of the kind having:—
a shank; and
a nut which is threadedly engageable with the shank;
wherein a part of the shank extrudes from an end face of the nut;
the method including:—
pulling the shank to achieve closure of a joint;
torquing the nut to maintain joint closure;
pulling the shank to free the nut from a surface of the closed joint; and
turning the nut substantially by a predetermined degree of rotation.
